(19) United States
(12) Patent Application Publication
(10) Pub. No.: US 2007/0150078 A1
(43) Pub. Date: Jun. 28, 2007

(54) Remote control system for equipment and optical signal transmitting device

(75) Inventors: Hideki Tanabe, Osaka (JP); Yasunari Miyake, Osaka (JP); Yasuo Masaki, Osaka (JP); Akinori Okazaki, Osaka (JP); Sadanori Murakami, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/527,026

(22) Filed: Sep. 26, 2006

(30) Foreign Application Priority Data
Sep. 26, 2005 (JP) 2005-278306

(51) Int. Cl. G05B 13/02

(52) U.S. Cl. 700/33

(57) ABSTRACT

An adapter is provided for allowing existing equipment to be controlled by a remote control device capable of controlling a plurality of equipment. A remote control adapter includes a reception circuit externally receiving an input of a signal, a flash memory, a control circuit generating a signal to be transmitted to a remote control device based on the received signal and the data stored in the flash memory, a transmitting circuit transmitting the generated signal and a battery. The control circuit includes a reception signal processing circuit obtaining information included in the signal from the reception circuit, and an optical ID (Identification) signal generation circuit generating identification information based on the obtained information and the data stored in the flash memory.

### BACKGROUND OF THE INVENTION

1. Field of the Invention

The present invention relates to a remote control system for equipment and an optical signal transmitting device. More particularly, the present invention relates to a technique for controlling equipment not having a function of transmitting identification information using a remote control device that controls particular equipment by recognizing any of a plurality of equipment capable of transmitting identification information.

2. Description of the Background Art

Televisions, VTR (Video Tape Recorder) and other equipment can be controlled by a control signal from a remote control device. Remote control devices are usually formed to be included with particular equipment. Alternatively, some remote control devices receive an input of unique data that is predetermined for each manufacturer of equipment to function as a remote control device for equipment corresponding to the data.

Here, a technique concerning a remote control system including equipment and a remote control device is disclosed, for example, in Japanese Patent Laying-Open No. 2004-048467, Japanese Unexamined Patent Publication No. 2005-506787, and Japanese Patent Laying-Open No. 2000-175276. Furthermore, a technique for controlling a plurality of equipment using one remote control device is disclosed, for example, in Japanese Patent Laying-Open No. 2000-050369.

### SUMMARY OF THE INVENTION

In order to allow one remote control device to remotely operate a plurality of equipment, it is necessary to change the configuration of a conventional remote control device and to change the configuration of equipment. For example, the remote control device is required to have a function of generating a control signal for controlling particular equipment and transmitting the signal.

On the other hand, in order for the equipment to perform a particular operation according to the signal transmitted from the remote control device, the equipment and the remote control device have to be related to each other. In this case, in order to establish their relationship, the user of the equipment is often required to perform a predetermined setting operation, for example, with reference to the manufacturer code indicated in the manual of VTR, HDD recorder and any other equipment. Therefore, it is sometimes impossible to set a remote control device that can control a plurality of equipment as a device for particular equipment.

In addition, for example, air conditioners and any other equipment other than the equipment as noted above may not provide a plurality of manufacturer codes on the manual of such equipment. In this case, such equipment is not to be remotely operated by the remote control device, resulting in limited improvement of convenience.

Moreover, in order to be remotely controlled by the remote control device, the equipment itself may have a function added to transmit a signal required by the remote control device. In this case, although the equipment that will be newly produced in the future may be adapted by changing its design, it is extremely difficult to add the above-noted function to the equipment that has already been produced as a finished product.

The present invention is made to solve the aforementioned problem. An object of the present invention is to provide a remote control system for equipment using existing equipment and a remote control device having a function of authenticating equipment and being capable of controlling a plurality of equipment to remotely control the existing equipment.

Another object of the present invention is to provide an optical signal transmitting device transmitting information for rendering existing equipment as a control target to a remote control device capable of controlling a plurality of equipment.

In summary, in order to solve the aforementioned problems, a remote control system for equipment in accordance with an aspect of the present invention includes an optical signal transmitting device transmitting an optical signal. The optical signal transmitting device includes a storage portion storing identification information for identifying the optical signal transmitting device, an optical signal generating portion generating an optical signal including the identification information, and a transmitting portion transmitting the optical signal generated by the generating portion as flashing light. The system further includes a remote control device for remotely operating control target equipment. The control target equipment receives a control signal transmitted by the remote control device to perform an operation defined by the control signal. The remote control device includes a light-receiving portion receiving the optical signal transmitted by the optical signal transmitting device, an analysis portion analyzing the optical signal received by the light-receiving portion to obtain the identification information, a control data obtaining portion obtaining control data for defining an operation realized by the control target equipment based on the identification information obtained by the analysis portion, an input portion externally receiving an input of an instruction, a control signal generating portion generating a control signal for controlling an operation of the control target equipment based on the control data obtained by the obtaining portion and the instruction, and an output portion outputting the control signal generated by the control signal generating portion.

Preferably, the remote control device further includes a request signal generating portion generating a request signal including a request for transmission of the identification information based on the instruction input through the input portion, and a transmitting portion transmitting the request signal. The optical signal transmitting device further includes a reception portion receiving the request signal, and a request obtaining portion obtaining the request for transmission of the identification information from the request signal received by the reception portion. The optical signal generating portion generates the optical signal in response to the request for transmission being obtained.

Preferably, an element used by the transmitting portion to transmit the request signal is identical to an element used by the output portion to output the control signal.

Preferably, the optical signal transmitting device further includes a reception portion receiving a control signal output by the remote control device, and a control signal transmitting portion transmitting the control signal received by the reception portion to the control signal receiving portion of the control target equipment.

Preferably, the light-receiving portion includes an image pickup portion picking up an image of the control target equipment to output a video signal. The image pickup portion has a plurality of pixels. The remote control device further includes a display portion displaying an image in a display area, and a drive portion reading each signal from each of the plurality of pixels. The drive portion reads each signal from each of the plurality of pixels corresponding to a predetermined partial area according to the display area and reads a signal from each pixel corresponding to the partial area faster than when reading each pixel corresponding to the entire display area. The analysis portion includes a detection portion detecting a flashing condition of the flashing light based on a signal read from each pixel corresponding to the partial area in response to picking up an image of the control target equipment, and an identification information obtaining portion obtaining the identification information based on the flashing condition.

Preferably, the remote control device further includes a control data storing portion storing a plurality of control data for defining each operation realized by each of a plurality of control target equipment. Each control data and the identification information are related with each other. The control data obtaining portion obtains the control data related with the identification information from each control data stored in the control data storing portion.

Preferably, the remote control device further includes a communication portion communicating via a communication line with an information providing device providing a plurality of control data for defining each operation realized by each of a plurality of control target equipment. The control data obtaining portion obtains control data for the control target equipment by transmitting the identification information to the information providing device.

A remote control system for equipment in accordance with another aspect of the present invention includes control target equipment. The control target equipment includes a control signal receiving portion receiving a control signal for controlling an operation of the control target equipment, and a control portion allowing the control target equipment to perform an operation defined by the control signal. The system further includes an optical signal transmitting device transmitting an optical signal. The optical signal transmitting device includes a storage portion storing identification information for identifying the optical signal transmitting device, an optical signal generating portion generating an optical signal including the identification information, and a transmitting portion transmitting the optical signal generated by the generating portion as flashing light. The system further includes a remote control device. The remote control device includes a light-receiving portion receiving the optical signal transmitted by the optical signal transmitting device, an analysis portion analyzing the optical signal received by the light-receiving portion to obtain the identification information, a control data obtaining portion obtaining control data for defining an operation realized by the control target equipment based on the identification information obtained by the analysis portion, an input portion externally receiving an input of an instruction, a control signal generating portion generating a control signal for controlling an operation of the control target equipment based on the control data obtained by the obtaining portion and the instruction, and an output portion outputting the control signal generated by the control signal generating portion.

Preferably, the remote control device further includes a request signal generating portion generating a request signal including a request for transmission of the identification information based on the instruction input through the input portion, and a transmitting portion transmitting the request signal. The optical signal transmitting device further includes a reception portion receiving the request signal, and a request obtaining portion obtaining the request for transmission of the identification information from the request signal received by the reception portion. The optical signal generating portion generates the optical signal in response to the request for transmission being obtained.

Preferably, the optical signal transmitting device further includes a reception portion receiving the control signal output from the remote control device, and a control signal transmitting portion transmitting the control signal received by the reception portion to the control signal receiving portion of the control target equipment.

Preferably, the light-receiving portion includes an image pickup portion picking up an image of the control target equipment to output a video signal. The image pickup portion has a plurality of pixels. The remote control device further includes a display portion displaying an image in a display area, and a drive portion reading each signal from each of the plurality of pixels. The drive portion reads each signal from each of the plurality of pixels corresponding to a predetermined partial area according to the display area and reads a signal from each pixel corresponding to the partial area faster than when reading each pixel corresponding to the entire display area. The analysis portion includes a detection portion detecting a flashing condition of the flashing light based on a signal read from each pixel corresponding to the partial area in response to picking up an image of the control target equipment, and an identification information obtaining portion obtaining the identification information based on the flashing condition.

Preferably, the remote control device further includes a control data storing portion storing a plurality of control data for defining each operation realized by each of a plurality of control target equipment. Each control data and the identification information are related with each other. The control data obtaining portion obtains the control data related with the identification information from each control data stored in the control data storing portion.

In accordance with another aspect of the present invention, an optical signal transmitting device for transmitting an optical signal to a remote control device is provided. The remote control device may receive from the optical signal transmitting device flashing light including specification information related with the optical signal transmitting device, obtain the specification information from the flashing light, and transmit to control target equipment control data related with the specification information for controlling an operation of the control target equipment. The optical signal transmitting device includes: a storage portion storing the specification information; a generation portion generating an optical signal including the specification information; and a transmitting portion transmitting the optical signal generated by the generation portion as flashing light.

Preferably, the specification information includes information for identifying control target equipment associated with the optical signal transmitting device.

Preferably, the specification information includes information for identifying the optical signal transmitting device.

Preferably, the optical signal transmitting device further includes an input portion externally receiving an input of information. The storage portion stores the information input through the input portion as the specification information.

Preferably, the optical signal transmitting device further includes a mounting portion for attaching the optical signal transmitting device to the control target equipment.

Preferably, the optical signal transmitting device further includes a reception portion receiving a request signal including a request for transmission of the identification information. The request signal is transmitted by the remote control device. The optical signal transmitting device includes a request obtaining portion obtaining the request for transmission of identification information from the request signal received by the reception portion. The generation portion generates the optical signal in response to the request for transmission being obtained.

Preferably, the control target equipment includes a control signal receiving portion receiving a control signal transmitted by the remote control device to control an operation of the control target equipment. The optical signal transmitting device further includes: a reception portion receiving the control signal output by the remote control device; and a control signal transmitting portion transmitting the control signal received by the reception portion to the control signal receiving portion.

Preferably, the optical signal transmitting device further includes a mounting portion for attaching the optical signal transmitting device to a front face of the control signal receiving portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a room 10 in which electronic equipment having a remote control adapter 200 in accordance with a first embodiment of the present invention mounted thereon is placed.

FIG. 2 illustrates a manner of attaching a remote control adapter 200a to a television 100.

FIG. 3 is a block diagram illustrating a functional configuration of remote control adapter 200.

FIG. 4 is a block diagram illustrating a hardware configuration of remote control adapter 200.

FIG. 5 illustrates a manner in which data is stored in a flash memory 430.

FIG. 6 is a flowchart illustrating a procedure of processes performed by a control circuit 420.

FIG. 7 schematically illustrates a configuration of an optical ID signal 700.

FIG. 8 shows an external view of a remote control device 130.

FIG. 9 is a block diagram illustrating a hardware configuration of remote control device 130.

FIG. 10 is a block diagram illustrating a specific configuration of a drive circuit 910.

FIG. 11 is a block diagram illustrating a functional configuration of a control circuit 920.

FIG. 12 schematically illustrates data stored in a memory 820 when remote control device 130 authenticates an air conditioner 110 as a control target.

FIG. 13 is a flowchart illustrating a procedure of processes performed by control circuit 920 to authenticate control target equipment.

FIG. 14 illustrates an image appearing on a display 802 when remote control device 130 performs a process of authenticating air conditioner 110.

FIG. 15 is a flowchart illustrating a procedure of processes performed by remote control device 130 to control the control target equipment.

FIG. 16 illustrates images displayed during authentication by remote control device 130.

FIG. 17 schematically illustrates data stored in memory 820 of remote control device 130 after authentication of an HDD recorder 120.

FIG. 18 is a flowchart illustrating a procedure of processes performed by remote control device 130 that has already authenticated control target equipment to authenticate another control target equipment.

FIG. 19 illustrates an image displayed when remote control device 130 recognizes HDD recorder 120.

FIG. 20 is a block diagram illustrating a functional configuration of a remote control adapter 2000.

FIG. 21 illustrates a manner in which data is stored in memory 820.

FIG. 22 illustrates an equipment selection screen appearing on display 802.

FIG. 23 is a flowchart illustrating a procedure of processes performed by control circuit 920 to authenticate equipment as a remote control device for controlling particular equipment.

FIG. 24 illustrates a positional relationship between television 100 and a remote control adapter 2400.

FIG. 25 is a block diagram illustrating a configuration of functions realized by remote control adapter 2400.

FIG. 26 is a flowchart illustrating a procedure of processes performed by an equipment control portion 2410.

### DESCRIPTION OF THE PREFERRED EMBODIMENTS

In the following, with reference to the figures, the embodiments of the present invention will be described. In the following description, the same parts will be denoted with the same reference characters. Their designations and functions are also the same. Therefore, detailed description thereof will not be repeated.

### First Embodiment

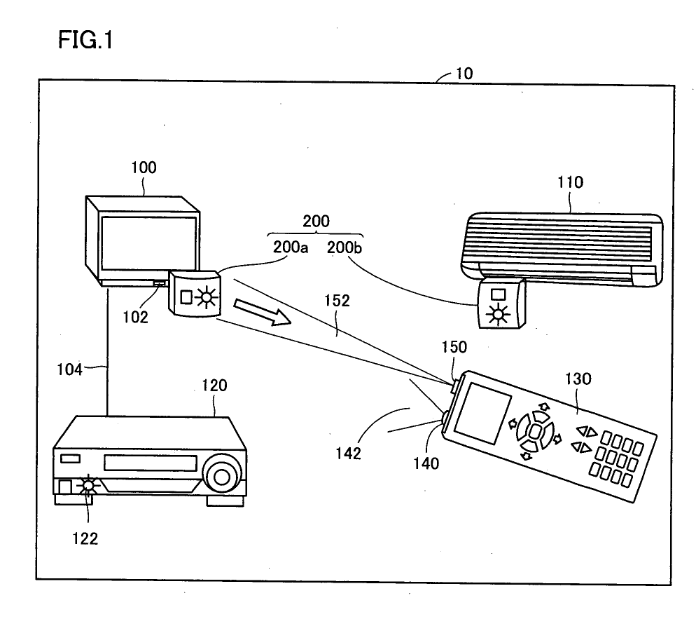

Referring to FIG. 1, a usage manner of a remote control adapter 200 in accordance with a first embodiment of the present invention will be described. FIG. 1 illustrates a room 10 in which electronic equipment having a remote control adapter mounted thereon is placed.

A television 100, an HDD recorder 120, and an air conditioner 110 are placed in room 10. Television 100 and HDD recorder 120 are connected to each other via a cable 104. A remote control adapter 200a in accordance with the first embodiment of the present invention is mounted on the front panel of television 100. Similarly, a remote control adapter 200b in accordance with the present embodiment is mounted on the front face of air conditioner 110. Remote control adapters 200a, 200b will be collectively referred to as remote control adapter 200. Remote control adapter 200a transmits an optical signal including identification information for identifying remote control adapter 200a as flashing light 152.

A remote control device 130 is also placed in room 10. Remote control device 130 includes a light-emitting portion 140 outputting a signal for controlling an operation of electronic equipment and a camera 150 picking up an image of a subject to obtain a video signal. Light-emitting portion 140 transmits a remote control signal 142 at a predetermined angle. Remote control signal 142 is, for example, infrared light.

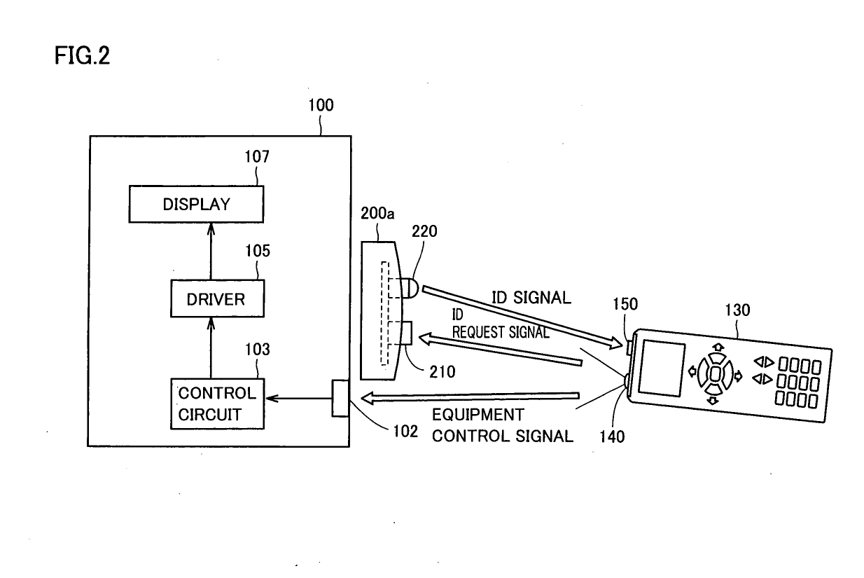

Referring to FIG. 2, a manner of attaching remote control adapter 200 in accordance with this embodiment will be described. FIG. 2 illustrates a manner of attaching remote control adapter 200a to television 100.

Remote control adapter 200a is attached at the front face of television 100 using an adhesive tape, a removable cloth tape and any other attachment member (not shown). Remote control adapter 200a includes a reception portion 210 externally receiving an ID (Identification) request signal requesting ID of remote control adapter 200a and a transmitting portion 220 transmitting an ID signal in response to the request. Arranged on the front face of television 100 (that is, the same face as the one having a display (not shown) placed thereon) a light-receiving portion 102 for receiving a control signal transmitted from remote control device 130. Television 100 further includes a display 107 displaying video, a control circuit 103 controlling the operation of television 100 based on the control signal received by light-receiving portion 102, and a driver 105 sending a video signal to display 107 based on the signal output from control circuit 103 for realizing video display. Control circuit 103 outputs a channel-selection command to a tuner (not shown) if the control signal includes an instruction to select a channel. If the control signal includes an instruction to up or down the volume, control circuit 103 sends an instruction to increase or reduce the intensity of an audio signal to an amplifier (not shown) based on the instruction. It is noted that the operation of television 100 is well known and therefore detailed description thereof will not be repeated here.

It is noted that the position where remote control adapter 200 is attached is not limited to the front face of control target equipment. As described later, remote control device 130 receives an optical ID signal transmitted from remote control adapter 200, obtains information included in the signal, and recognizes remote control adapter 200 based on the information. Therefore, remote control adapter 200 may be attached at a position allowing the user of remote control device 130 to pick up an image of remote control adapter 200, in other words, in the vicinity of the equipment. For example, it may preferably be attached in the vicinity of the light-receiving portion receiving a signal from the remote control device unique to the equipment, in front of remote control device 130.

Furthermore, the attachment manner is not limited to the one described above. Remote control adapter 200 may be attached magnetically or may be stationary. For example, when remote control adapter 200 is attached to the equipment installed at a higher place, such as air conditioner 110, a magnet or an adhesive tape is preferably employed for secure attachment. In the case of the equipment installed on a base, such as HDD recorder 120, remote control adapter 200 may be stationary, in addition to a magnet or a tape.

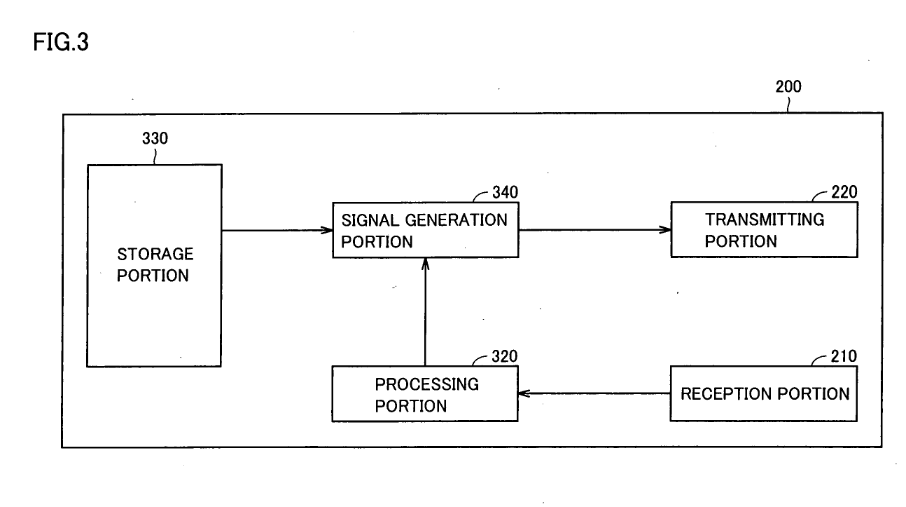

Referring to FIG. 3, the configuration of remote control adapter 200 will be described. FIG. 3 is a block diagram illustrating the functional configuration of remote control adapter 200. Remote control adapter 200 includes a reception portion 210, a processing portion 320, a storage portion 330, a signal generation portion 340, and a transmitting portion 220.

Reception portion 210 receives a signal transmitted from remote control device 130 for transfer to processing portion 320. Processing portion 320 obtains information included in the signal. This information includes a request for data for identifying remote control adapter 200. Processing portion 320 feeds the obtained information to signal generation portion 340. Storage portion 330 stores data beforehand for identifying remote control adapter 200. Signal generation portion 340 generates an ID signal to be transmitted to remote control device 130 based on the data stored in storage portion 330. Signal generation portion 340 sends the signal to transmitting portion 220. Transmitting portion 220 transmits the signal as an optical signal at predetermined flashing intervals. The optical signal corresponds, for example, to flashing light 152 shown in FIG. 1. Transmitting portion 220 includes, for example, LED (Light Emitting Diode) or the like.

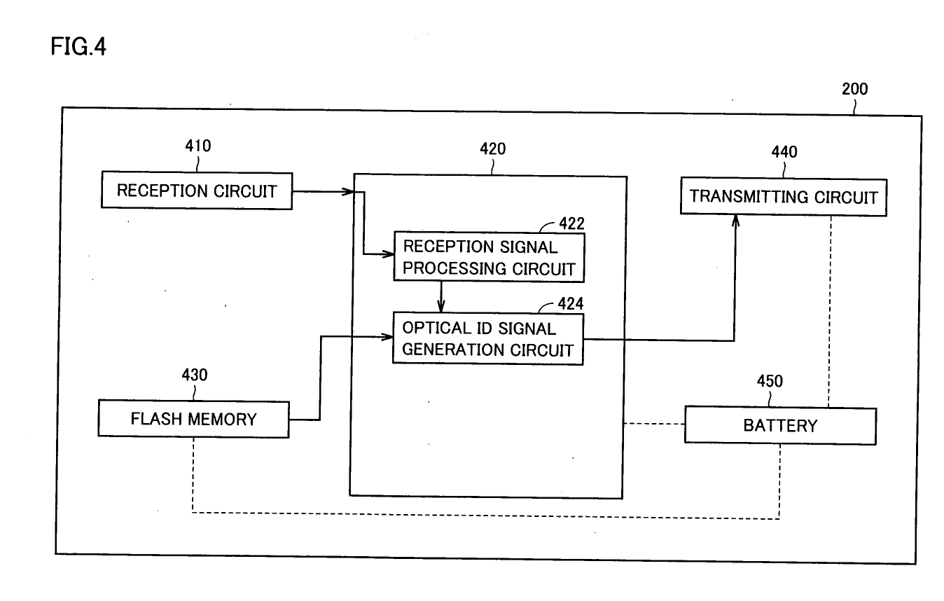

Referring to FIG. 4, the configuration of remote control adapter 200 will be further described. FIG. 4 is a block diagram illustrating the hardware configuration of remote control adapter 200. Remote control adapter 200 includes a reception circuit 410 externally receiving an input of a signal, a flash memory 430 for storing data in a nonvolatile manner, a control circuit 420 for generating a signal to be transmitted to remote control device 130 based on the signal received by reception circuit 410 and the data stored in flash memory 430, a transmitting circuit 440 for transmitting a signal generated by control circuit 420, and a battery 450 supplying power for driving remote control adapter 200. Control circuit 420 includes a reception signal processing circuit 422 receiving an input of a signal sent from reception circuit 410 to obtain information included in the signal, and an optical ID signal generation circuit 424 generating identification information to be transmitted as an optical signal based on the information (for example, an instruction to transmit identification information) obtained by reception signal processing circuit 422 and the data stored in flash memory 430.

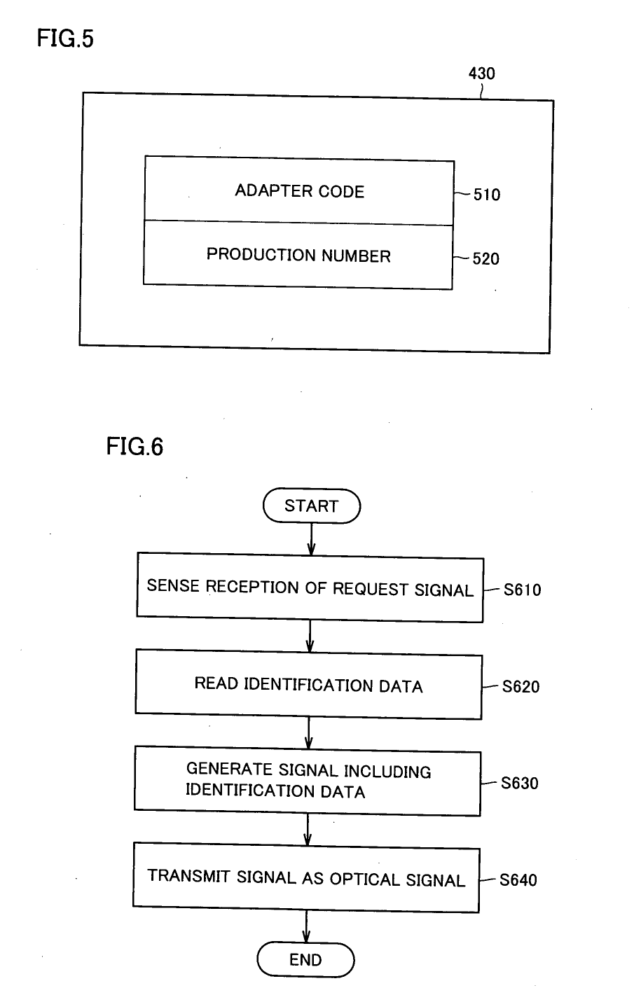

Referring to FIG. 5, the data structure of remote control adapter 200 will be described. FIG. 5 illustrates a manner in which data is stored in flash memory 430. Flash memory 430 includes areas 510, 520 for storing data. The adapter code for identifying remote control adapter 200 is stored in area 510. The production number assigned by the manufacture in production of remote control adapter 200 is stored in area 520. Remote control adapter 200 is specified by the adapter code and the production number. Such data is read by optical ID signal generation circuit 424 thereby generating an optical signal.

It is noted that data stored in flash memory 430 for specifying remote control adapter 200 is not limited to the one shown in FIG. 5. Alternatively, the data may be overwritten. The manner in which the data is modified will be described later.

Referring to FIG. 6, the control structure of remote control adapter 200 in accordance with the present embodiment will be described. FIG. 6 is a flowchart illustrating a procedure of processes performed by control circuit 420. This process is performed, for example, when remote control adapter 200 externally receives infrared light having a particular wavelength during a so-called sleep mode.

At step S610, control circuit 420 senses reception of a request signal requesting an ID signal based on a signal received by reception circuit 410. The request signal is transmitted from remote control device 130, for example, when the user inputs an instruction to request an ID signal in remote control device 130. At this point, remote control device 130 generates a signal including the request signal and outputs the signal through light-emitting portion 140.

At step S620, control circuit 420 reads identification data (for example, an adapter code, production number, and the like) stored in flash memory 430. At step S630, control circuit 420 generates an ID signal including the read identification data. At step S640, control circuit 420 allows transmitting circuit 440 to transmit the ID signal as a flashing optical signal. Accordingly, remote control adapter 200 transmits a signal including information for identifying itself as an optical signal in a predetermined direction.

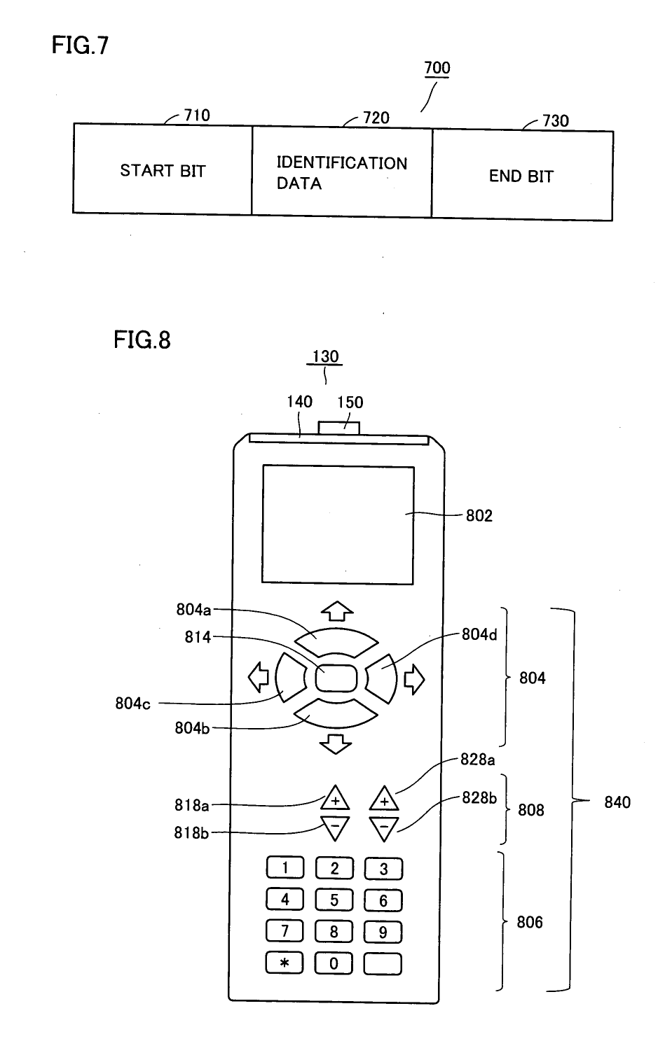

Referring to FIG. 7, the configuration of optical ID signal 700 transmitted by remote control adapter 200 will be described. FIG. 7 schematically illustrates the configuration of optical ID signal 700. Optical ID signal 700 includes areas 710, 720, 730 for transmitting data.

The start bit representing the head of optical ID signal 700 is included in area 710. The identification data of remote control adapter 200 is included in area 720. The end bit representing the end of optical ID signal 700 is included in area 730. Optical ID signal 700 shown in FIG. 7 is periodically transmitted from remote control adapter 200. Optical ID signal 700 is transmitted for a predetermined time, for example, for a certain period of time after the sleep mode is cleared. In this case, the head of each optical ID signal 700 is specified by the start bit, so that remote control device 130 receiving such a signal can easily specify the head of optical ID signal 700.

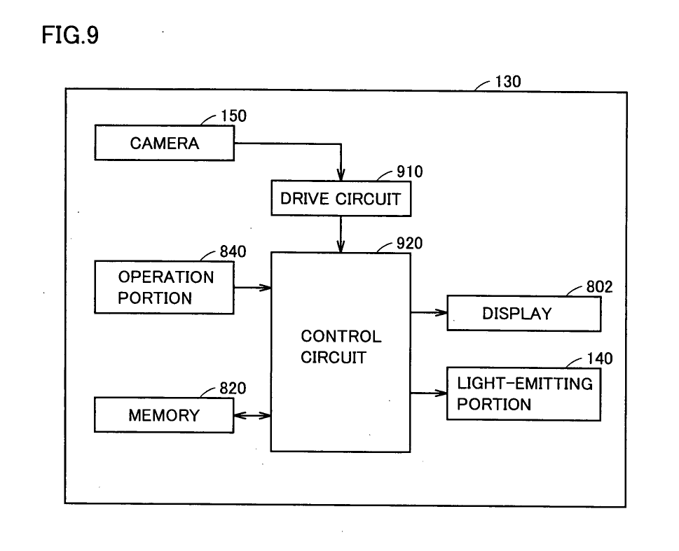

Referring to FIGS. 8 and 9, remote control device 130 in accordance with this embodiment will be described. FIG. 8 shows an external view of remote control device 130.

Remote control device 130 includes a camera 150 picking up an image of a subject to output a video signal, a light-emitting portion 140 emitting a control signal to control target equipment, a display 802, and an operation portion 840 externally receiving an input of an instruction to output a signal according to the input. Camera 150 is realized, for example, by a light-receiving element having a photoelectric conversion function and an element having a signal transfer function such as CCD (Charge Coupled Device). Display 802 is realized by a liquid crystal display, an organic EL (Electro Luminescent) display, or the like.

Operation portion 840 is realized, for example, by a button or a dial. Operation portion 840 includes cursor buttons 804a, 804b, 804c, 804d defining up/down and right/left directions of the cursor appearing on display 802, a decision button 814 receiving an input of an instruction to confirm data input by the user of remote control device 130, an up/down button 808 for upping or downing the value of the output control signal, and a numeric button 806. Up/down button 808 includes a first up button 818a, a first down button 818b, a second up button 828a, and a second down button 828b.

FIG. 9 is a block diagram illustrating a hardware configuration of remote control device 130. Remote control device 130 includes camera 150, a drive circuit 910 receiving an input of a signal output from camera 150, operation portion 840 externally receiving an input of an instruction, a control circuit 920 generating a signal for remote control device 130 to perform a predetermined process based on the externally input data or command, a memory 820 for reading and writing data, display 802 displaying an image based on a signal generated by control circuit 920, and a light-emitting portion 140 outputting a signal generated by control circuit 920.

The signal generated by drive circuit 910 is input to control circuit 920. Control circuit 920 performs predetermined image processing on the signal and generates data for displaying an image on display 802. Operation portion 840 outputs an electrical signal to control circuit 920 according to the input instruction. Control circuit 920 performs a predetermined process according to the signal. Camera 150 receives an optical signal including a control signal that is predetermined between control target equipment and remote control device 130. Camera 150 has a photoelectric conversion function and converts the signal to an electrical signal based on the function to send the converted signal to drive circuit 910.

Memory 820 is a memory for storing data in a nonvolatile manner. Memory 820 is realized, for example, by a flash memory. Memory 820 receives an input of data for specifying a function of control target equipment from control circuit 920 for storage into a predetermined area.

When remote control device 130 functions as a remote control for the control target equipment, control circuit 920 generates a signal for performing a predetermined process based on the data stored in an area of memory 820. Control circuit 920 sends the generated signal to light-emitting portion 140. Control circuit 920 may be realized by a circuit element preliminary configured to perform each process or may be realized by causing CPU (Central Processing Unit) or any other processing unit to execute a program for realizing each process.

Light-emitting portion 140 transmits the control signal output from control circuit 920 to the outside. In one aspect, light-emitting portion 140 transmits an infrared signal. In another aspect, light-emitting portion 140 is connected to, for example, a communication line to perform a process for transmitting the control signal as a packet. The manner of outputting the control signal is not limited to an infrared signal and may be transmission according to, for example, Bluetooth® and any other wireless communication technique.

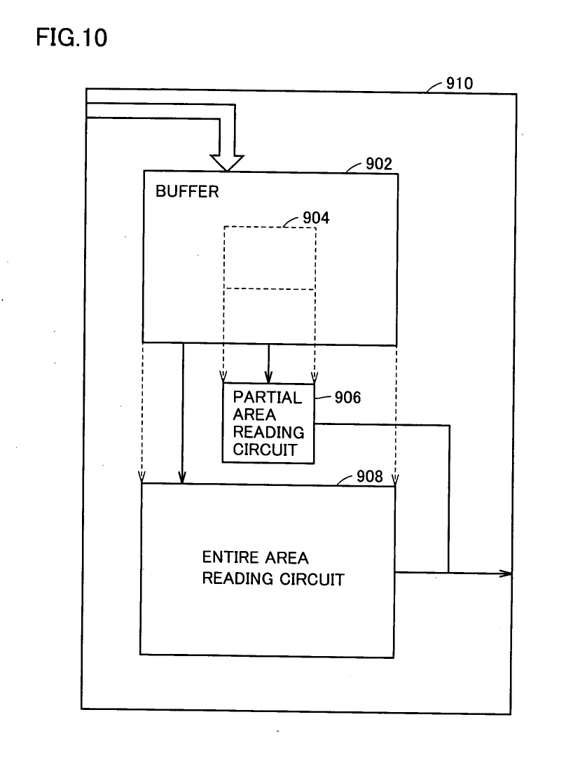

Referring to FIG. 10, drive circuit 910 in accordance with this embodiment will be further described. FIG. 10 is a block diagram illustrating a specific configuration of drive circuit 910. Drive circuit 910 analyzes an input signal to obtain information included in the signal, for example, identification information for specifying the source of the signal.

Drive circuit 910 includes a buffer 902 receiving an input of a video signal from camera 150 to store the signal, an entire area reading circuit 908 reading data corresponding to the entire area that is defined in buffer 902 corresponding to the display area of display 802, and a partial area reading circuit 906 reading data stored in a partial area 904 defined in buffer 902 as an area corresponding to the partial area defined as a partial area of the display area in display 802.

Entire area reading circuit 908 reads a signal stored in buffer 902 at a predetermined processing speed. The read signal is sent to control circuit 920. When display 802 displays an image based on the signal, the enter image of a subject picked up by camera 150 appears in the entire display area of display 802.

Partial area reading circuit 906 reads a signal stored in partial area 904 in buffer 902. In this case, the reading speed is higher than the speed of reading from the entire area of buffer 902. More specifically, the area to be read by partial area reading circuit 906 is smaller than the area to be read by entire area reading circuit 908, so that the signal stored in partial area 904 is read faster than the signal corresponding to the entire area. Partial area reading circuit 906 successively reads data faster than entire area reading circuit 908 and sends the data to control circuit 920.

In this way, control circuit 920 can perform a signal reading process faster than the normal image processing based on the image picked up by camera 150. As a result, even if a subject is standing still, a signal, for example infrared light, sent from the subject is picked up by camera 150 at a predetermined partial area, whereby information can be obtained based on the signal.

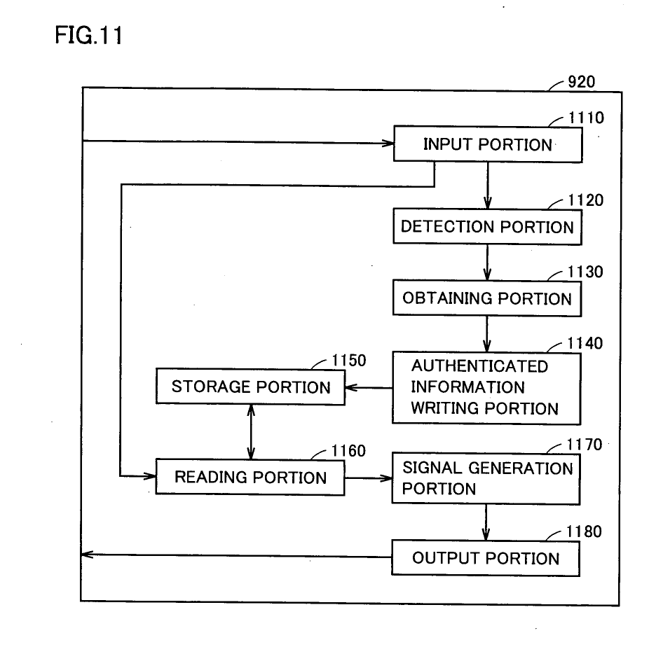

Now, referring to FIG. 11, the functional configuration of control circuit 920 of remote control device 130 will be described. FIG. 11 is a functional block diagram of control circuit 920.

Control circuit 920 includes an input portion 1110 externally receiving an input of a signal, a detection portion 1120 detecting information stored in the signal based on the signal received by input portion 1110, an obtaining portion 1130 obtaining particular information from the detected signal, an authenticated information writing portion 1140 performing a process for storing authenticated information based on the obtained information, a storage portion 1150 storing data, a reading portion 1160 reading data stored in storage portion 1150 based on an input through input portion 1110, a signal generation portion 1170 generating a signal for controlling control target equipment based on data read by reading portion 1160, and an output portion 1180 outputting a signal generated by signal generation portion 1170.

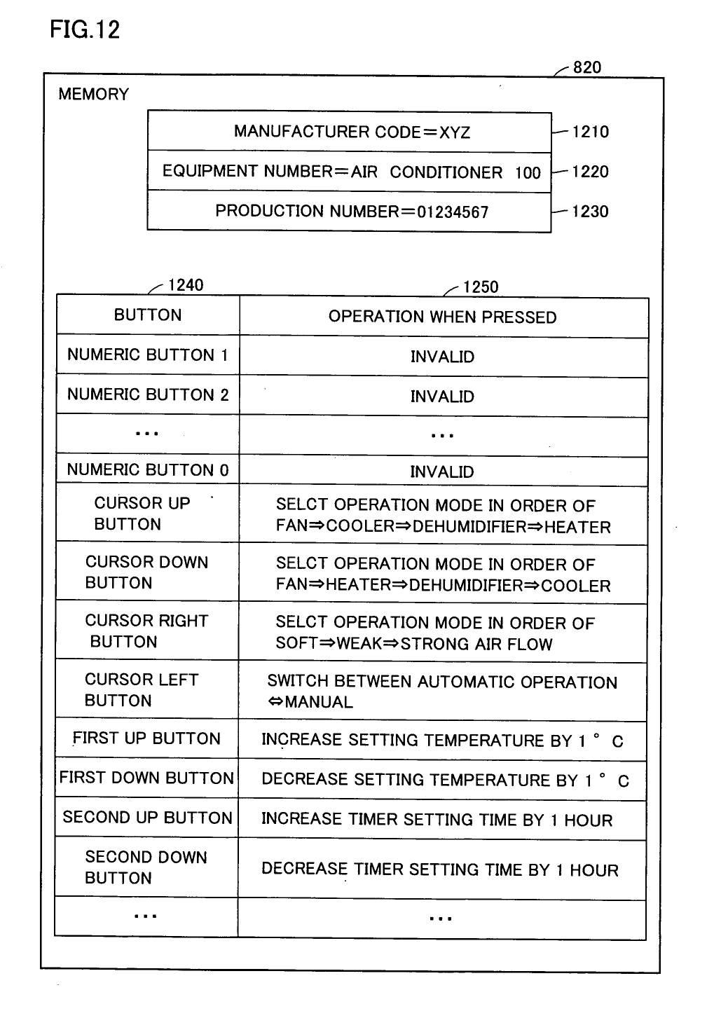

Referring to FIG. 12, the data structure of remote control device 130 will be described. FIG. 12 schematically illustrates data stored in memory 820 when remote control device 130 authenticates air conditioner 110 as a control target. Memory 820 includes areas 1210-1250 for storing data.

The manufacturer code (“XYZ”) of air conditioner 110 is stored in area 1210. The equipment number (“AIR CONDITIONER 100”) of air conditioner 110 is stored in area 1220. The production number (“01234567”) is stored in area 1230.

Furthermore, in memory 820, the buttons provided as operation portion 840 of remote control device 130 are related with the respective operations of the buttons when pressed. For example, the “cursor up button” (cursor button 804a in FIG. 8) included in area 1240 is set to switch the operation modes in the order of a fan, a cooler, a dehumidifier and heater when it is pressed.

On the other hand, the first up button (up button 818a in FIG. 8) is set to output a control signal to up the setting temperature of air conditioner 110 by 1° C. (degree Celsius) when it is pressed. Similarly, the second up button (up button 828a in the same figure) is set to output a control signal to increase the timer setting time of air conditioner 110 by one hour.

On the other hand, numeric buttons “1” to “0” are set not to output any control signal even when they are pressed. Specifically, the signal output in response to pressing the button represents “invalid”. In this manner, a press on the button is not related to any particular operation, so that even when the button is erroneously pressed, no control signal is output, thereby preventing an error. The above-noted setting for preventing a malfunction can be applied to the buttons other than numeric buttons according to control target equipment associated with remote control device 130.

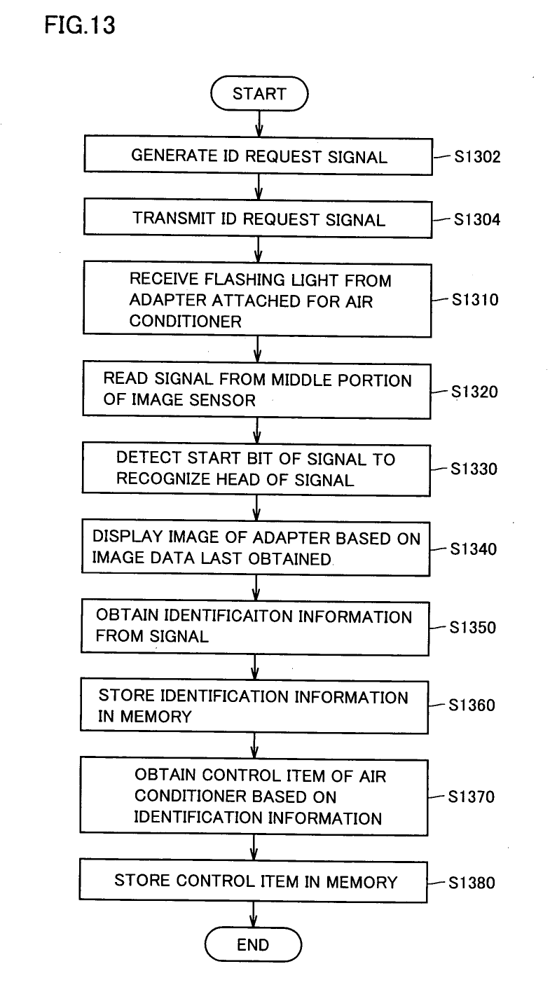

Referring to FIG. 13, the control structure of remote control device 130 in accordance with the present embodiment will be described. FIG. 13 is a flowchart illustrating a procedure of processes performed by control circuit 920 to authenticate control target equipment.

At step S1302, control circuit 920 generates an ID request signal requesting transmission of identification information of a remote control adapter based on the user's instruction input through operation portion 840. At step S1304, control circuit 920 sends the ID request signal through light-emitting portion 140. The ID request signal is transmitted within a predetermined radiation range. If a remote control adapter exists within this range, the ID request signal is received by the remote control adapter (step S610), so that the remote control adapter transmits an optical signal including identification information.

At step S1310, control circuit 920 receives flashing light transmitted by remote control adapter 200b provided in the vicinity of air conditioner 110. At step S1320, control circuit 920 reads a signal obtained at the middle portion of camera 150 functioning as an image sensor. At step S1330, control circuit 920 recognizes the head of the signal by detecting the start bit of the signal. At step S1340, control circuit 920 allows the image of air conditioner 110 including remote control adapter 200b to appear on display 802 based on the image data last obtained by camera 150.

At step S1350, control circuit 920 obtains identification information of remote control adapter 200b from the obtained information. At step S1360, control circuit 920 stores the obtained identification information in an area allocated for an authentication process in memory 820.

At step S1370, control circuit 920 obtains a control item of air conditioner 110 related to remote control adapter 200b based on the identification information. Here, the control item refers to a process item that may be controlled by remote control device 130, of the functions that can be performed by air conditioner 110. At step S1380, control circuit 920 stores the obtained control item in a data area allocated beforehand in memory 820.

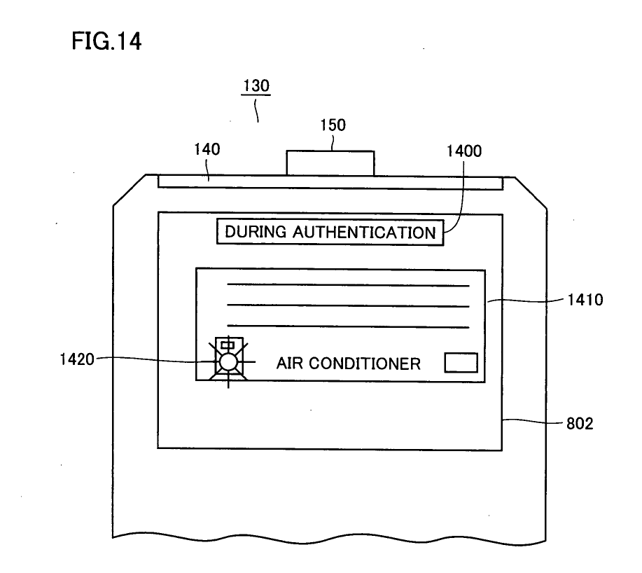

Now, referring to FIG. 14, a display manner on display 802 of remote control device 130 will be described. FIG. 14 illustrates an image appearing on display 802 when remote control device 130 performs a process of authenticating air conditioner 110.

Remote control device 130 displays an image 1410 of air conditioner 110 and an image 1420 of remote control adapter 200b on display 802. Here, remote control device 130 displays a message 1400 indicating that an authentication process is being performed. Therefore, the user of remote control device 130 can easily recognize the present state of remote control device 130.

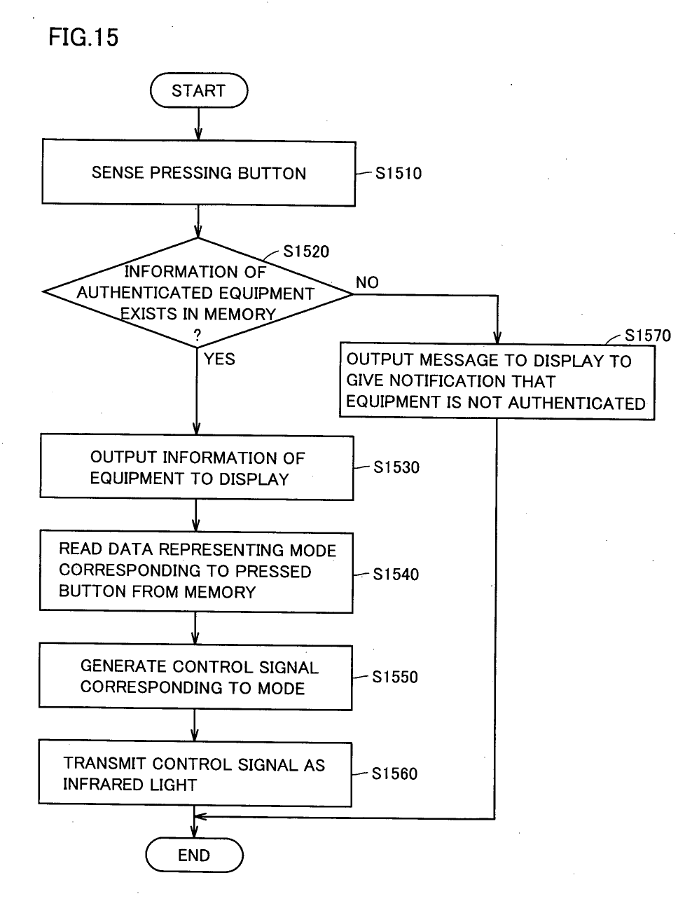

Now, referring to FIG. 15, the control structure of remote control device 130 will be described again. FIG. 15 is a flowchart illustrating a procedure of processes performed by remote control device 130 to control the control target equipment. This process is performed when the user uses remote control device 130 as a remote control device dedicated to particular control target equipment (for example, HDD recorder 120, television 100, or air conditioner 110).

At step S1510, control circuit 920 senses a press on a button based on an input through operation portion 840. At step S1520, control circuit 920 determines whether or not information of the authenticated equipment exists in memory 820 based on a signal from operation portion 840. If the information exists in memory 820 (YES at step S1520), the process moves on to step S1530. If not (NO at step S1520), the process moves on to step S1570.

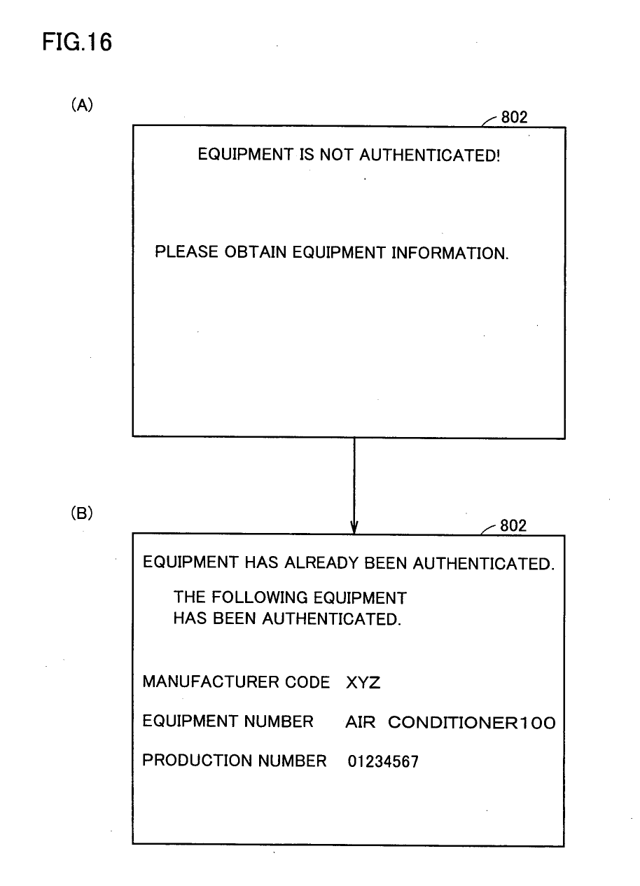

At step S1530, control circuit 920 outputs information of the authenticated equipment to display 802. The information of the equipment then appears on display 802. This display manner will be described with reference to FIG. 16.

At step S1540, control circuit 920 reads data representing the mode corresponding to the pressed button which is stored in memory 820. At step S1550, control circuit 920 generates a control signal corresponding to the mode. At step S1560, control circuit 920 transmits the control signal as infrared light through light-emitting portion 140.

At step S1570, control circuit 920 outputs a message to display 802 to give notification that the equipment is not authenticated. Display 802 displays the message in the display area.

Referring to FIG. 16, a manner of displaying an image on display 802 will be described. FIG. 16 illustrates an image displayed during authentication by remote control device 130.

An image (A) represents an image displayed when control target equipment is not authenticated by remote control device 130. More specifically, display 802 displays a message that authentication of control target equipment has not been completed and a message that prompts for obtaining information of the equipment. This display is realized, for example, by storing the data in memory 820 in advance and reading the data when the process at the above-noted step S1570 is performed. Such display allows the user of remote control device 130 to promptly recognize that the authentication process has not been completed. In this case, the user directs remote control device 130 to transmitting portion 220 of remote control adapter 200 to obtain optical ID signal 700, ensuring that the process of authenticating control target equipment is realized.

An image (B) represents an image displayed when control target equipment has been authenticated. In this case, remote control device 130 displays information of the equipment on display 802 based on the data stored in memory 820, as shown in FIG. 16. In the example shown in image (B), it is displayed that the equipment with the manufacturer code “XYZ”, the equipment number “AIR CONDITIONER 100”, the production number “01234567” is authenticated as the authenticated equipment. It is noted that the information included in image (B) is not limited to the one stored in memory 820. For example, the information may be included directly in the optical ID signal. The optical ID signal having such an item can be transmitted by the user of remote control device 130 to input the information beforehand in remote control adapter 200b. For example, the user can input the information when attaching remote control adapter 200b to air conditioner 110.

Here, remote control device 130 functions as a remote control device for another control target equipment by way of illustration. In the following, remote control device 130 which initially functions as a remote control device for air conditioner 110 will function as a remote control device for HDD recorder 120 after the process of authenticating control target equipment is performed again.

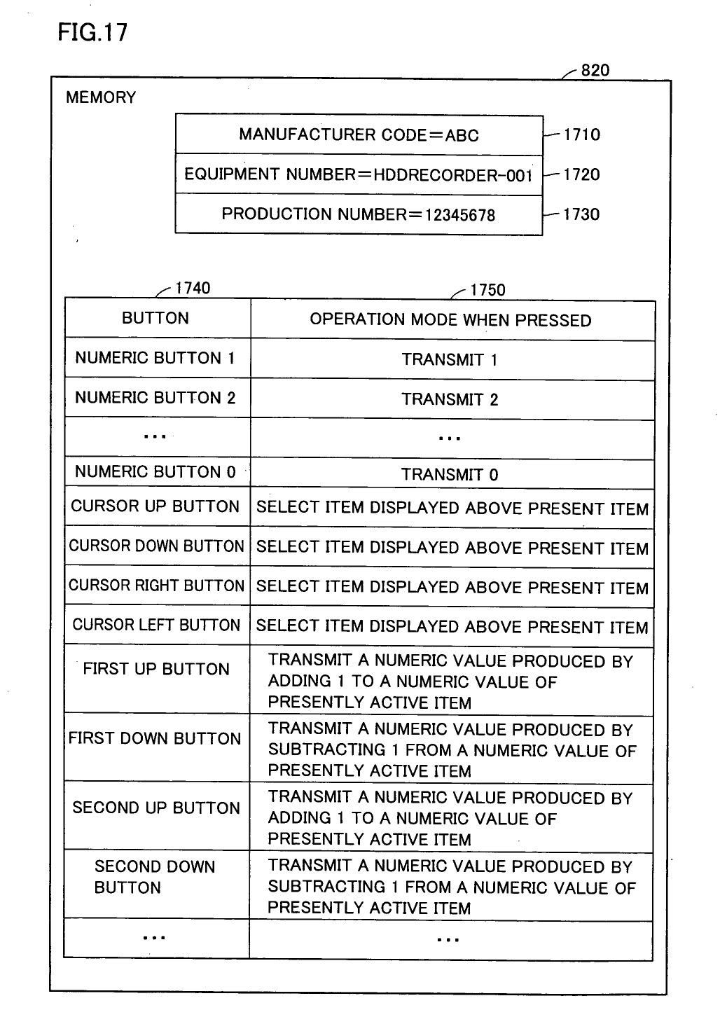

Referring now to FIG. 17, the data structure of remote control device 130 will be described. FIG. 17 schematically illustrates data stored in memory 820 of remote control device 130 after authentication of HDD recorder 120. When remote control device 130 authenticates HDD recorder 120, data show in FIG. 17 is used in place of data shown in FIG. 12 to generate a signal for controlling HDD recorder 120. As a result, remote control device 130, which has functioned to remotely operate air conditioner 110, now functions as a remote control device for HDD recorder 120.

Specifically, memory 820 includes areas 1710-1750 for storing data. The manufacturer code “ABC” of HDD recorder 120 is stored in area 1710. The equipment number “HDDRECORDER-001” of HDD recorder 120 is stored in area. 1720. The production number “12345678” of HDD recorder 120 is stored in area 1730.

The information identifying each button provided as operation portion 840 of remote control device 130 is stored in area 1740. An operation mode, which is related with each button, at the time of pressing the button is stored in area 1750. For example, the numeric button “1” is set to transmit data of “1” when the button is pressed. On the other hand, the “cursor up button” is set to perform a process for selecting an item displayed above the item presently appearing on display 802, when the button is pressed. Furthermore, for example, “the first up button ” is set to be able to transmit a value produced by adding “1” to the value of the presently active item (that is the controllable item) when the button is pressed. For example, if the first up button functions as a button for selecting a channel, the channel number is upped by one when the first up button is pressed.

Since the data stored in area 1740 and the data stored in area 1750 are related to each other, remote control device 130 can generate and transmit a signal controlling the operation of HDD recorder 120 as control target equipment in response to a press on each button.

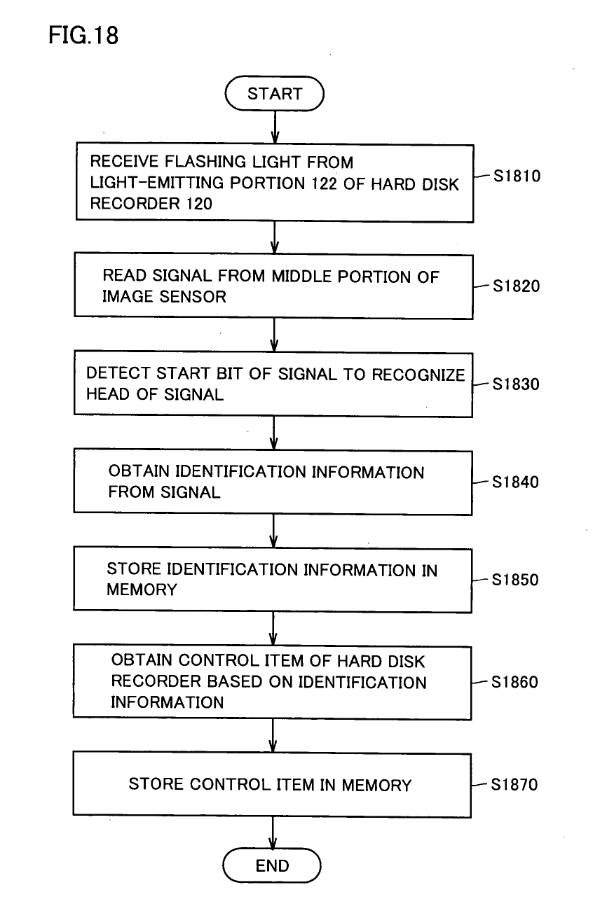

Now, referring to FIG. 18, the control structure of remote control device 130 will further be described. FIG. 18 is a flowchart illustrating a procedure of processes performed by remote control device 130 that has already authenticated control target equipment to authenticate another control target equipment. These processes are realized, for example, when the user of remote control device 130 that has already authenticated air conditioner 110 directs remote control device 130 to HDD recorder 120 to perform a process of picking up an image of HDD recorder 120.

Here, HDD recorder 120 has a light-emitting portion 122 transmitting an optical ID signal including a manufacturer code, equipment number, production number and any other identification information as flashing light by way of illustration. It is noted that HDD recorder 120 may have remote control adapter 200 in accordance with the present invention in place of light-emitting portion 122.

At step S1810, control circuit 920 receives flashing light transmitted by light-emitting portion 122 of HDD recorder 110 through camera 150. At step S1820, control circuit 920 reads a signal obtained at the middle portion of an image sensor (camera 150) through drive circuit 910.

At step S1830, control circuit 920 recognizes the head of the signal by detecting the start bit of the signal. At step S1840, control circuit 920 obtains identification information included in the signal. At step S1850, control circuit 920 writes the identification information (that is, the manufacturer code, equipment number, production number and the like of HDD recorder 120) in a data area of memory 820.

At step S1860, control circuit 920 obtains a control item of HDD recorder 120 based on the identification information of HDD recorder 120. Since the control target equipment being now authenticated is HDD recorder 120, its control item includes, for example, recording start and stop, reproduction start and stop, and any other items concerning recording/reproduction functions, channel selection or up and down and any other items concerning television broadcast receiving functions, moving or selecting a cursor displayed on the operation screen and any other items concerning data editing functions, and the like. At step S1870, control circuit 920 stores the obtained control item in memory 820 (FIG. 17). Thus, when an instruction for remote control device 130 is thereafter input through operation portion 840, remote control device 130 can generate and transmit a signal controlling HDD recorder 120.

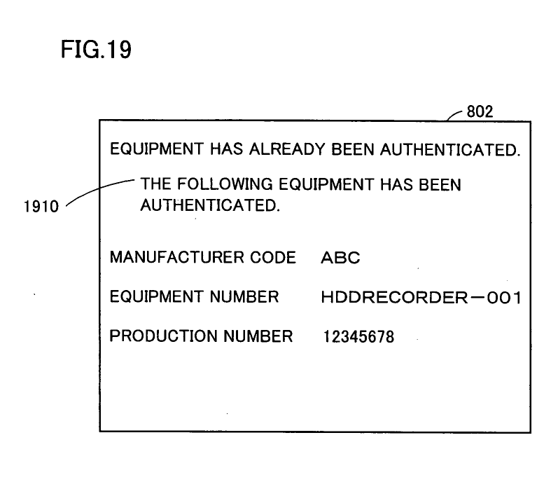

Referring to FIG. 19, a manner of displaying an image on display 802 of remote control device 130 will be further described. FIG. 19 illustrates an image displayed when remote control device 130 recognizes HDD recorder 120.

When the user directs remote control device 130 to light-emitting portion 122 of HDD recorder 120 to perform an operation for receiving a signal, remote control device 130 performs the aforementioned authentication process to recognize HDD recorder 120. Remote control device 130 obtains identification information included in the signal received from HDD recorder 120 to write the information in memory 820. In this case, if another control target equipment has already been authenticated, the information is written into another data area of memory 820. Alternatively, the area into which data has already been written is overwritten with data for the newly recognized equipment.

Upon completion of the authentication process, remote control device 130 displays a message 1910 on display 802 to give notification that new equipment has been authenticated. Here, display 802 displays information for HDD recorder 120 as the authenticated control target equipment. In this way, information of specific equipment is displayed according to the recognition state of remote control device 130, so that the user of remote control device 130 can operate the equipment without an error.

As described above, remote control adapter 200 in accordance with the present invention is attached in the vicinity of equipment to be controlled based on a signal of a remote control device. Remote control adapter 200 transmits identification information stored in flash memory 430 as a flashing optical signal. The identification information includes the production number and serial number of remote control adapter 200, and any other number unique to remote control adapter 200. Receiving an optical signal including such information, remote control device 130 relates the signal with control information for performing an operation specific to the equipment. As a result, remote control device 130 receiving the optical signal can function as a terminal for remotely operating the equipment.

When remote control device 130 thereafter receives an optical signal from another remote control adapter transmitting an optical signal having a similar configuration, remote control device 130 can authenticate another equipment having another remote control adapter attached thereto. In this way, one remote control device 130 can function as a device for controlling a plurality of equipment.

In other words, remote control adapter 200 is attached in the vicinity of the conventional equipment not having a function of transmitting an optical signal, and the equipment and the remote control adapter are associated with each other. Accordingly, the equipment is to be controlled by remote control device 130. Therefore, it is no longer necessary to modify the control structure of the equipment itself, thereby easily realizing equipment that can be controlled by one remote control device 130.

<First Modification>

In the following, a first modification to the present embodiment will be described. A remote control adapter 2000 in accordance with this modification differs from remote control adapter 200 in accordance with the embodiment described above in that it has a function of modifying identification data.

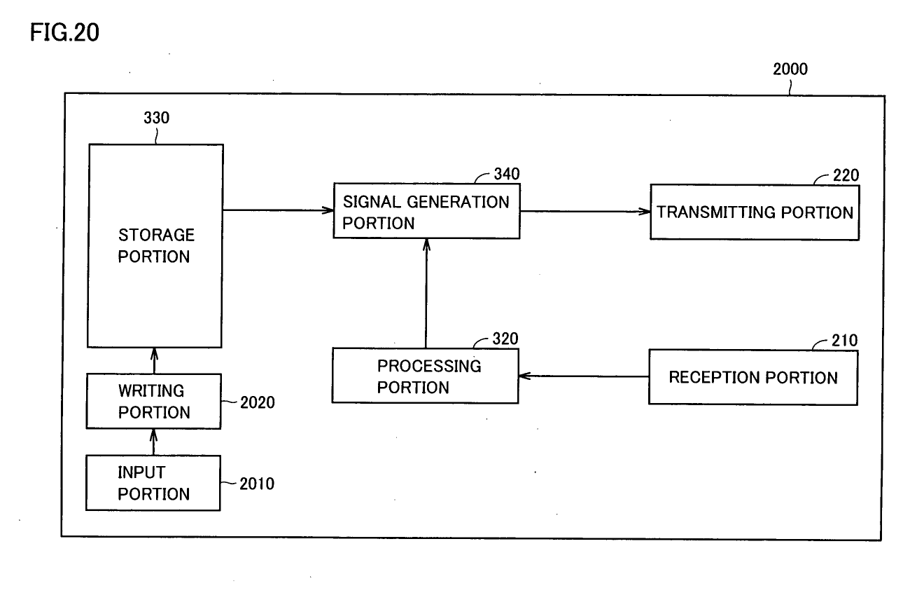

Referring to FIG. 20, the configuration of remote control adapter 2000 in accordance with this modification will be described. FIG. 20 is a block diagram illustrating a functional configuration of remote control adapter 2000. In addition to the configuration shown in FIG. 3, remote control adapter 2000 includes an input portion 2010 externally receiving an input of information and a writing portion 2020 writing the data received by input portion 2010 in storage portion 330.

Input portion 2010 is, for example, a touch-panel type button provided on the front face of remote control adapter 2000 or a DIP switch or a jumper switch for the user of remote control adapter 2000 to input data. Data input through input portion 2010 is updated by writing portion 2020 in the area in which identification data is stored in storage portion 330. Writing portion 2020 is, for example, a circuit element configured to perform a predetermined process to update data.

As a result, remote control adapter 2000 can use data input by the user of remote control adapter 2000 as data for identifying itself, in place of data preset by the manufacturer of remote control adapter 2000 as described above. In this way, when a plurality of remote control adapters are used by the same user, the user can give an easily distinguishable name to each remote control adapter 2000, thereby facilitating management of the remote control adapters. It is noted that input data may be either numerals or characters.

<Second Modification>

In the following, a second modification to the present embodiment will be described. In order for remote control device 130 to function as a remote control for particular equipment based on a signal transmitted from the above-noted remote control adapter, its information needs to be obtained beforehand. The remote control device in accordance with this modification holds data of controllable equipment beforehand and realizes display for allowing the user to select equipment according to identification information included in the received optical ID signal. The user of the remote control device refers to the display to set the device as a remote control device for particular equipment.

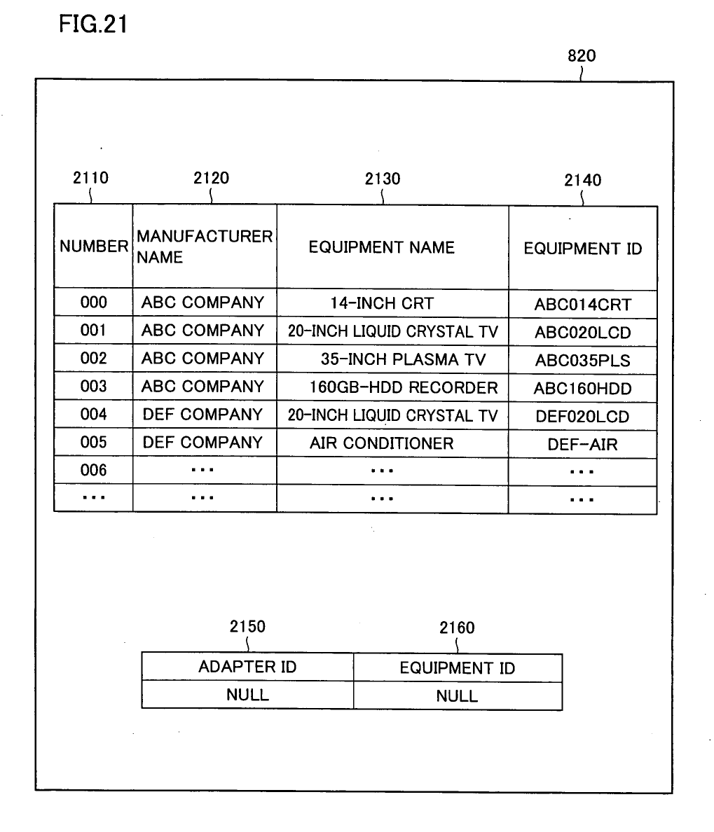

Referring to FIG. 21, the data structure of the remote control device in accordance with this modification will be described. FIG. 21 illustrates a manner in which data is stored in memory 820. Memory 820 includes areas 2110-2160 for storing data.

Data for specifying a record of data stored in memory 820 is stored in area 2110. Data representing the manufacturer of the equipment that can be controlled by remote control device 130 is stored in area 2120. Data for specifying the equipment is stored in area 2130. ID uniquely provided to the equipment is stored in area 2140. The data stored in areas 2110 to 2140 are related with one another. Therefore, when the data stored in area 2110 is specified, the name, ID and manufacturer of the equipment controlled by remote control device 130 are also specified based on the data.

Further referring to FIG. 21, in memory 820, adapter ID for specifying remote control adapter 200 is stored in area 2150. The equipment ID for specifying the equipment controlled by remote control adapter 200 is stored in area 2160. The data stored in area 2150 and the data stored in area 2160 are related with each other. Because of this relation, remote control device 130 can function as a remote control device for controlling particular equipment.

Here, as shown in FIG. 21, the identification information of remote control adapter 200 is not obtained before remote control 130 recognizes remote control adapter 200. Therefore, no data is stored in area 2150. Instead, “NULL” is stored representing that no data is stored in the area. This is applicable to the data in area 2160.

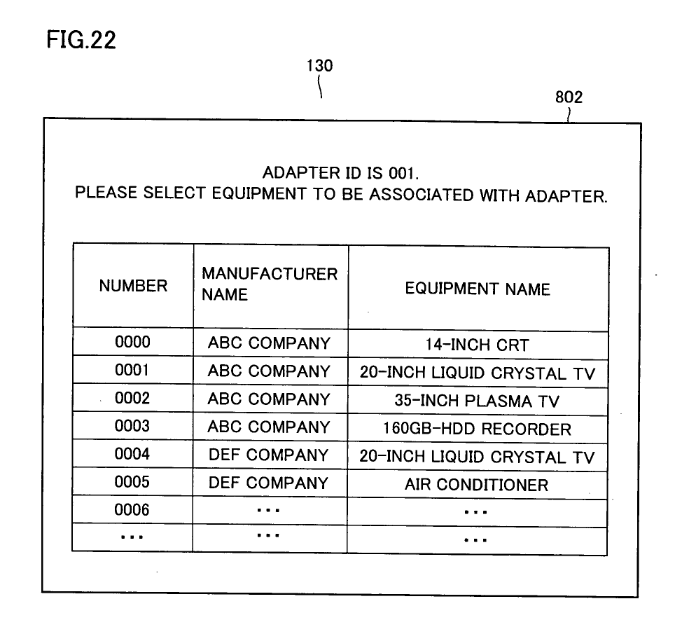

Now, referring to FIG. 22, a display manner of remote control device 130 in accordance with this modification will be described. FIG. 22 illustrates an equipment selection screen appearing on display 802.

Display 802 displays a list of equipment that may be controlled by remote control device 130 based on the data stored in memory 820. When the user of remote control device 130 selects any equipment from the displayed equipment and inputs an instruction to select it, for example, through operation portion 840, remote control device 130 functions as a remote control device for controlling the selected equipment. For example, the data stored beforehand in memory 820 is used for data for realizing the function.

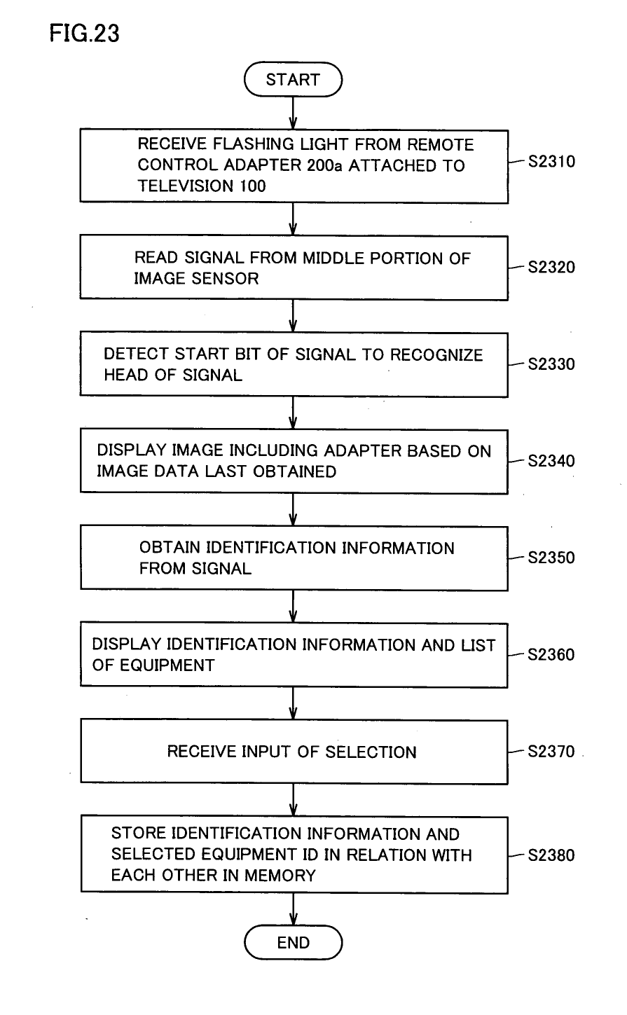

Referring to FIG. 23, the control structure of remote control device 130 in accordance with this modification will be described. FIG. 23 is a flowchart illustrating a procedure of processes performed by control circuit 920 to authenticate equipment as a remote control device for controlling particular equipment.

At step S2310, control circuit 920 receives the flashing optical signal from remote control adapter 200a attached in the vicinity of television 100. At step S2320, control circuit 920 reads a signal received from the middle portion of the image sensor through drive circuit 910. At step S2330, control circuit 920 detects the start bit of the signal to recognize the head of the ID signal. At step S2340, control circuit 920 displays an image of television 100 including remote control adapter 200a based on the image data last obtained. At step S2350, control circuit 920 obtains identification information of the remote control adapter from optical ID signal 700.

At step S2360, control circuit 920 causes identification data of remote control adapter 200a and a list for selecting equipment (for example, FIG. 22) to appear on display 802 based on the obtained information and the data stored in memory 820. At step S2370, control circuit 920 receives an input of equipment selected from the displayed list through operation portion 840. At step S2380, control circuit 920 stores the identification information and the selected equipment ID in relation with each other in an area allocated beforehand in memory 820.

As described above, the remote control device in accordance with this modification stores information of a plurality of equipment to be remotely operated in the memory. Upon reception of an optical ID signal from remote control adapter 200 associated with control target equipment, the remote control device obtains identification information included in the signal and displays a screen for relating the equipment and the identification information with each other. The user of the remote control device selects any equipment from a plurality of equipment and inputs into the remote control device an instruction to relate identification information and the selected equipment with each other, so that the remote control device thereafter operates as a device remotely operating the equipment related with remote control adapter 200. In this way, a screen for selecting equipment is displayed in the remote control device, so that the user can accurately relate equipment and identification information with each other.

### Second Embodiment

In the following, a second embodiment of the present invention will be described. A remote control adapter 2400 in accordance with the present embodiment differs from remote control adapter 200 in accordance with the embodiment described above in that it has a function of transmitting a control signal received from remote control device 130 to control target equipment.

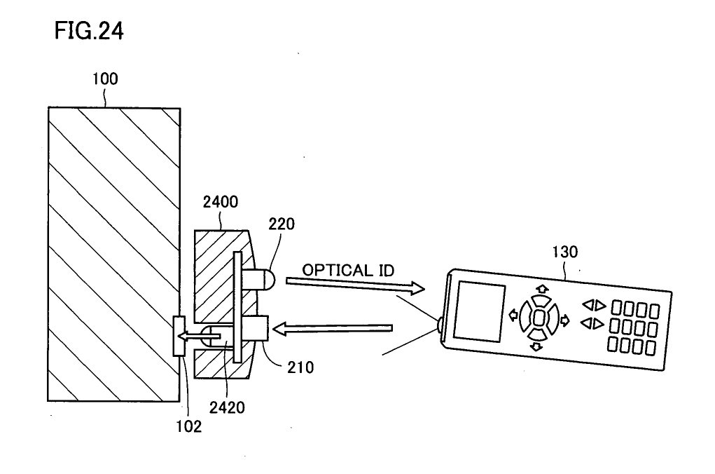

Referring to FIG. 24, an attachment manner of remote control adapter 2400 in accordance with the present embodiment will be described. FIG. 24 illustrates a positional relationship between television 100 and remote control adapter 2400.

Remote control adapter 2400 is attached to television 100 by an adhesive tape (not shown) such that a control signal transmitting portion 2420 is opposed to remote control light-receiving portion 102. In other words, a control signal transmitted from control signal transmitting portion 2420 is received at remote control light-receiving portion 102.

Remote control adapter 2400 includes, similarly to the configuration shown in FIG. 2, light-receiving portion 210 receiving a control signal transmitted from remote control device 130 and transmitting portion 220 transmitting an optical ID signal as flashing light.

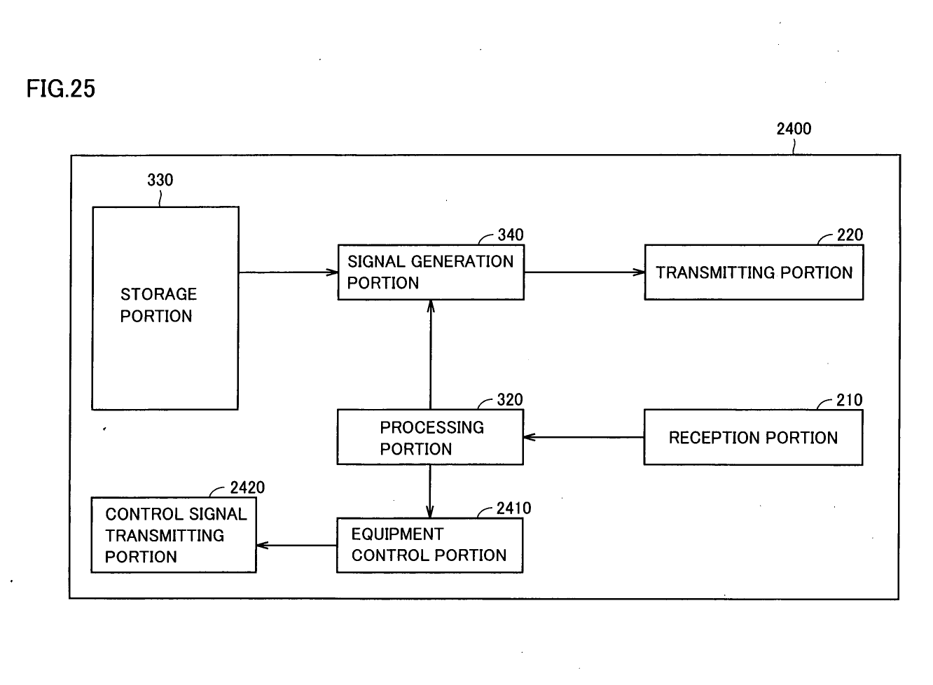

Referring to FIG. 25, the configuration of remote control adapter 2400 in accordance with the present embodiment will be described. FIG. 25 is a block diagram illustrating the configuration of the function realized by remote control adapter 2400. In addition to the configuration shown in FIG. 3, remote control adapter 2400 includes an equipment control portion 2410 generating a signal for controlling equipment based on a signal obtained by processing portion 320 and a control signal transmitting portion 2420 converting a signal generated by equipment control portion 2410 into an infrared signal and transmitting the converted signal.

Processing portion 320 detects whether or not the signal received by reception portion 210 is a control signal for controlling particular equipment. Upon sensing reception of the control signal, processing portion 320 sends the signal to equipment control portion 2410.

Equipment control portion 2410 converts the signal in a signal format for transmission as a remote control code to the equipment and sends the converted signal to control signal transmitting portion 2420. In this way, irrespective of the signal transmitting function of remote control device 130, the signal transmitted from remote control device 130 to control the equipment is transmitted from control signal transmitting portion 2420 in a format according to the equipment. This may prevent a malfunction of equipment resulting from disagreement of the control signal format.

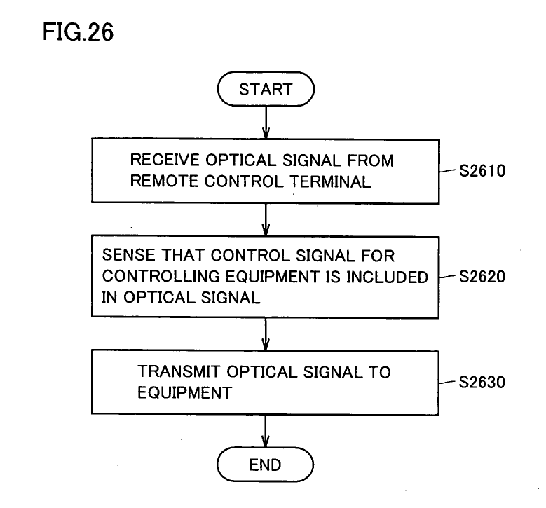

Referring to FIG. 26, the control structure of remote control adapter 2400 will be described. FIG. 26 is a flowchart illustrating a procedure of processes performed by equipment control portion 2410.

At step S2610, equipment control portion 2410 senses that a signal for controlling equipment is received from remote control device 130 based on a signal output from processing portion 320. The reception of the signal is sensed, for example, when information representing the signal is included in the header of the signal transmitted from remote control device 130.

At step S2620, equipment control portion 2410 obtains control data for controlling control target equipment from the control signal. Equipment control portion 2410 generates a control signal using the control data in accordance with the format of the signal received by the equipment.

At step S2630, equipment control portion 2410 transmits the generated signal through control signal transmitting portion 2420. Accordingly, the control signal transmitted by remote control device 130 is transmitted to remote control light-receiving portion 102 of television 100 through remote control adapter 2400. The format of the control signal transmitted from remote control adapter 2400 agrees with the format of the signal received by television 100. Therefore, television 100 performs an operation defined by the information included in the control signal without a malfunction resulting from disagreement in signal format.

As described above, remote control adapter 2400 in accordance with the second embodiment of the present invention relays a control signal of equipment transmitted by remote control device 130 and re-transmits the control signal to the equipment. In this way, even if the signal transmission function of remote control device 130 does not completely agree with the format of the signal received by the equipment, remote control adapter 2400 converts and transmits the signal in the format of the signal received by the equipment, thereby ensuring that the operation of equipment designated by remote control device 130 can be performed by the equipment.

In addition, since remote control adapter 2400 is attached on the front face of the remote control signal light-receiving portion of equipment, remote control adapter 2400 appears integrated with the equipment. Therefore, the user of conventional equipment is less likely to feel uncomfortable with the attached remote control adapter 2400.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A remote control system for equipment, comprising:
an optical signal transmitting device transmitting an optical signal, said optical signal transmitting device including
a storage portion storing identification information for identifying said optical signal transmitting device,
an optical signal generating portion generating an optical signal including said identification information, and
a transmitting portion transmitting the optical signal generated by said generating portion as flashing light; and
a remote control device for remotely operating control target equipment, said control target equipment receiving a control signal transmitted by said remote control device to perform an operation defined by said control signal, said remote control device including
a light-receiving portion receiving the optical signal transmitted by said optical signal transmitting device,
an analysis portion analyzing the optical signal received by said light-receiving portion to obtain said identification information,
a control data obtaining portion obtaining control data for defining an operation realized by said control target equipment based on the identification information obtained by said analysis portion,
an input portion externally receiving an input of an instruction,
a control signal generating portion generating a control signal for controlling an operation of said control target equipment based on the control data obtained by said obtaining portion and said instruction, and
an output portion outputting the control signal generated by said control signal generating portion.

2. The remote control system for equipment according to claim 1, wherein
said remote control device further includes
a request signal generating portion generating a request signal including a request for transmission of said identification information based on the instruction input through said input portion, and
a transmitting portion transmitting said request signal,
said optical signal transmitting device further includes
a reception portion receiving said request signal, and
a request obtaining portion obtaining said request for transmission of said identification information from the request signal received by said reception portion, and
said optical signal generating portion generates said optical signal in response to said request for transmission being obtained.

3. The remote control system for equipment according to claim 2, wherein an element used by said transmitting portion to send said request signal is identical to an element used by said output portion to output said control signal.

4. The remote control system for equipment according to claim 1, wherein said optical signal transmitting device further includes
a reception portion receiving a control signal output by said remote control device, and
a control signal transmitting portion transmits the control signal received by said reception portion to said control signal receiving portion of said control target equipment.

5. The remote control system for equipment according to claim 1, wherein
said light-receiving portion includes an image pickup portion picking up an image of said control target equipment to output a video signal, said image pickup portion having a plurality of pixels,
said remote control device further includes
a display portion displaying an image in a display area, and
a drive portion reading each signal from each of said plurality of pixels, said drive portion reading each signal from each of said plurality of pixels corresponding to a predetermined partial area according to said display area and reading a signal from each said pixel corresponding to said partial area faster than when reading each said pixel corresponding to entire said display area, and
said analysis portion includes
a detection portion detecting a flashing condition of said flashing light based on a signal read from each said pixel corresponding to said partial area in response to picking up an image of said control target equipment, and
an identification information obtaining portion obtaining said identification information based on said flashing condition.

6. The remote control system for equipment according to claim 1, wherein
said remote control device further includes a control data storing portion storing a plurality of said control data for defining each operation realized by each of a plurality of control target equipment, each said control data and said identification information being related with each other, and
said control data obtaining portion obtains said control data related with said identification information from each said control data stored in said control data storing portion.

7. The remote control system for equipment according to claim 1, wherein said remote control device further includes a communication portion communicating via a communication line with an information providing device providing a plurality of said control data for defining each operation realized by each of a plurality of control target equipment, and
said control data obtaining portion obtains control data for said control target equipment by transmitting said identification information to said information providing device.

8. A remote control system for equipment comprising:
control target equipment including
a control signal receiving portion receiving a control signal for controlling an operation of said control target equipment, and
a control portion allowing said control target equipment to perform an operation defined by said control signal;
an optical signal transmitting device transmitting an optical signal, said optical signal transmitting device including
a storage portion storing identification information for identifying said optical signal transmitting device,
an optical signal generating portion generating an optical signal including said identification information, and
a transmitting portion transmitting the optical signal generated by said generating portion as flashing light; and
a remote control device including
a light-receiving portion receiving the optical signal transmitted by said optical signal transmitting device,
an analysis portion analyzing the optical signal received by said light-receiving portion to obtain said identification information,
a control data obtaining portion obtaining control data for defining an operation realized by said control target equipment based on the identification information obtained by said analysis portion,
an input portion externally receiving an input of an instruction,
a control signal generating portion generating a control signal for controlling an operation of said control target equipment based on the control data obtained by said obtaining portion and said instruction, and
an output portion outputting the control signal generated by said control signal generating portion.

9. The remote control system for equipment according to claim 8, wherein
said remote control device further includes
a request signal generating portion generating a request signal including a request for transmission of said identification information based on the instruction input through said input portion, and
a transmitting portion transmitting said request signal,
said optical signal transmitting device further includes
a reception portion receiving said request signal, and
a request obtaining portion obtaining said request for transmission of said identification information from the request signal received by said reception portion, and
said optical signal generating portion generates said optical signal in response to said request for transmission being obtained.

10. The remote control system for equipment according to claim 8, wherein said optical signal transmitting device further includes
a reception portion receiving the control signal output from said remote control device, and
a control signal transmitting portion transmitting the control signal received by said reception portion to said control signal receiving portion of said control target equipment.

11. The remote control system for equipment according to claim 8, wherein
said light-receiving portion includes an image pickup portion picking up an image of said control target equipment to output a video signal, said image pickup portion having a plurality of pixels,
said remote control device further includes
a display portion displaying an image in a display area, and
a drive portion reading each signal from each of said plurality of pixels, said drive portion reading each signal from each of said plurality of pixels corresponding to a predetermined partial area according to said display area and reading a signal from each said pixel corresponding to said partial area faster than when reading each said pixel corresponding to entire said display area, and
said analysis portion includes
a detection portion detecting a flashing condition of said flashing light based on a signal read from each said pixel corresponding to said partial area in response to picking up an image of said control target equipment, and
an identification information obtaining portion obtaining said identification information based on said flashing condition.

12. The remote control system for equipment according to claim 8, wherein
said remote control device further includes a control data storing portion storing a plurality of said control data for defining each operation realized by each of a plurality of control target equipment, each said control data and said identification information being related with each other, and
said control data obtaining portion obtains said control data related with said identification information from each said control data stored in said control data storing portion.

13. An optical signal transmitting device for transmitting an optical signal to a remote control device, wherein said remote control device is capable of receiving from said optical signal transmitting device flashing light including specification information related with said optical signal transmitting device, obtaining said specification information from said flashing light, and transmitting to control target equipment control data related with said specification information for controlling an operation of said control target equipment, said optical signal transmitting device comprising:
a storage portion storing said specification information;
a generation portion generating an optical signal including said specification information; and
a transmitting portion transmitting the optical signal generated by said generation portion as flashing light.

14. The optical signal transmitting device according to claim 13, wherein said specification information includes information for identifying control target equipment associated with said optical signal transmitting device.

15. The optical signal transmitting device according to claim 13, wherein said specification information includes information for identifying said optical signal transmitting device.

16. The optical signal transmitting device according to claim 13, further comprising an input portion externally receiving an input of information, wherein
said storage portion stores the information input through said input portion as said specification information.

17. The optical signal transmitting device according to claim 13, further comprising a mounting portion for attaching said optical signal transmitting device to said control target equipment.

18. The optical signal transmitting device according to claim 13, further comprising:
a reception portion receiving a request signal including a request for transmission of said specification information, said request signal being transmitted by said remote control device; and
a request obtaining portion obtaining said request for transmission of said specification information from the request signal received by said reception portion, wherein
said generation portion generates said optical signal in response to said request for transmission being obtained.

19. The optical signal transmitting device according to claim 13, wherein
said control target equipment includes a control signal receiving portion receiving a control signal transmitted by said remote control device to control an operation of said control target equipment, said optical signal transmitting device further comprising:
a reception portion receiving said control signal output by said remote control device; and
a control signal transmitting portion transmitting the control signal received by said reception portion to said control signal receiving portion.

20. The optical signal transmitting device according to claim 19, further comprising a mounting portion for attaching said optical signal transmitting device to a front face of said control signal receiving portion.
